(19) United States
(12) Patent Application Publication
(10) Pub. No.: US 2015/0342228 A1
(43) Pub. Date: Dec. 3, 2015

(54) INFRARED PROCESSING TECHNOLOGY FOR THE PRODUCTION OF DRIED CRUNCHY VEGETABLE/FRUIT INGREDIENTS AND SNACKS

(71) Applicants: Leslie Marie Norris, San Rafael, CA (US); Megan Alexander Fisklements, Oakland, CA (US); Edward Hirschberg, South San Francisco, CA (US); Mattison Peters, Berkeley, CA (US); Erica Kenny, Davis, CA (US)

(72) Inventors: Leslie Marie Norris, San Rafael, CA (US); Megan Alexander Fisklements, Oakland, CA (US); Edward Hirschberg, South San Francisco, CA (US); Mattison Peters, Berkeley, CA (US); Erica Kenny, Davis, CA (US)

(21) Appl. No.: 14/292,845

(22) Filed: May 31, 2014

(51) Int. Cl. A23L 1/01; A23B 7/10; A23B 7/157; A23L 1/212

(52) U.S. Cl. CPC A23L 1/0128; A23L 1/2123; A23B 7/10; A23B 7/157; A23V 2002/00

(57) ABSTRACT

A method for producing food includes pre-treating an edible item with one or more solutions to preserve or enhance texture, color, or flavor of the item, wherein the item is a fruit or a vegetable; either (a) blanching with far-infrared, pulsed electric field, or microwave treatment and then applying a coating matrix; or (b) applying a coating matrix and then blanching with far-infrared, pulsed electric field, or microwave treatment; bringing a final water content to less than 6% with a finishing dehydration operation; and forming a final product as a shelf-stable, low-fat crunchy vegetable-based or fruit-based ingredient or snack.

### BACKGROUND

The present invention relates to an improved method of processing dried vegetables and fruit into crunchy snacks.

Dried fruits and vegetables are commonly made by steam-blanching, followed by hot air drying or freeze drying to remove water absorbed during blanching and the moisture naturally present in fresh produce. By using dry blanching, we avoid the addition of water, and remove 30-60% of the naturally present moisture. This makes post-blanch drying much more efficient.

Dry blanching such as IR blanching has already been shown to decrease nutrient loss, color loss, and improve crunchy texture compared to hot air drying and freeze drying (Shih et al., 2008; Vishwanathan et al., 2013)

U.S. Pat. No. 4,749,579 discloses the production of a reduced-fat potato chip, preheating the potato slice with IR, then frying it, with the finished food product being 26-32% oil by weight.

U.S. Pat. No. 8,277,858 discloses infrared heating of potato slices or starch-based food or dough, and U.S. Pat. No. 5,747,087 discloses infrared heating of potato slices. U.S. Pat. No. 4,948,609 refers to the production of dry fruits & vegetables that maintain their color and appearance, using vacuum-drying to create food products with a puffed, smooth texture. The three patents involve expansion or puffing of the product while the current invention utilizes drying at ambient pressure to avoid expansion of the final product.

U.S. Pat. No. 4,800,090 discloses the use of microwave and IR heating to heat the surface and interior of the potato chips in order to create a chip made without frying. This patent specifically refers to a three-step sequential combination of infrared treatment to heat the outside of the food piece, followed by microwave to heat the inside of the food piece, and then infrared treatment again to brown the food piece. U.S. Pat. Nos. 5,470,600 and 5,560,287 disclose the use of radiant heat (to release the glucose from the potato), two stages of forced air convection heat and a final dielectric heat (long wavelength radio frequency) step to create a potato chip made without frying. These three patents do not claim enzyme inactivation, water removal, or the use of a matrix to create a food piece with a three-dimensional structure yielding a crunchy texture.

Furthermore, U.S. Pat. No. 5,747,087 discloses that microwave costing can be prohibitively expensive and potentially dangerous to worker safety.

### SUMMARY

In one aspect, a method for producing food includes pre-treating an edible item with one or more solutions to preserve or enhance texture, color, or flavor of the item, wherein the item is a fruit or a vegetable; either (a) blanching with far-infrared, pulsed electric field, or microwave treatment and then applying a coating matrix; or (b) applying a coating matrix and then blanching with far-infrared, pulsed electric field, or microwave treatment; bringing a final water content to less than 6% with a finishing dehydration operation; and forming a final product as a shelf-stable, low-fat crunchy vegetable or fruit-based ingredient or finished snack.

Implementations of the above aspects may include one or more of the following. The pre-treatment operation can include a solution containing weak acid or acids. The pre-treatment operation can include a solution containing mineral salt or salts. The matrix may include starches, syrups, and gums such as potato, tapioca, gum arabic, maltodextrin, and cellulose individually or in combination. The matrix may include oil at a level between 0.5%-20% of the final product. In certain cases, some of the matrix is applied before infrared heating, such as starches that have not been pre-gelatinized, but become gelatinized during the infrared heating. The coating matrix may be comprised of a very small amount of oil (not necessarily, but possibly, as little as 1% compared to fruit/veg fresh weight). Infrared blanching, pulsed electric field treatment, and microwave blanching will be referred to as dry blanching for the purposes of this document. The infrared radiation wavelength may be between 0.78 micrometers and 1000 micrometers. More specifically, it may be between 1-12 micrometers. The infrared intensity may be between 3000-5000 W/m². The finishing dehydration operation may occur between 50-165 degrees Celsius. Endogenous enzymes of the original fruit or vegetable can be substantially or essentially inactivated, particularly those enzymes that cause or hasten loss of color, nutrition, texture, and flavor. The final food product thus produced retains much of the original micronutrients, such as, but not necessarily or exclusively, vitamin C or beta carotene, compared to other commercially common methods of combined blanching and drying, such as the application of hot water or steam followed by hot air drying. Additionally, the final food product can retain much of the original vegetable or fruit flavor, possibly heightened by caramelized or roasted notes. In one embodiment, the combination of infrared treatment and coating matrix creates a brittle food piece that shatters during the initial stages of chewing, and furthermore, the added matrix melts upon rehydration in the mouth without giving a viscous organoleptic sensation in the mouth. This shattering results in the expedited disappearance of vegetable matter during chewing, rather than the formation of a cohesive pulp that lingers in the mouth during chewing. In another embodiment, the combination of infrared heating and the matrix described of claim 1 form a novel microstructure, wherein the plant tissue compresses down and cements to itself more compactly, and with no or very few interstitial spaces preserved within the tissue. In one form, this compressed tissue is more crunchy (requires more peak force to fracture), compared to the same plant tissue without either infrared blanching, or a matrix, or without both. In one form, the enhanced crunchiness may be due to the cemented food piece breaking all at once, rather than a more aerated food piece breaking in sequential portions, with the breaking interrupted by interstitial spaces or pores. In one form, vegetable tissue treated this way is also significantly less flexible than the same plant tissue without either infrared blanching, or a matrix, or both.

Advantages of the above methods may include one or more of the following. The method produces a healthy (low fat, low sugar) dried vegetable or fruit snack with (1) a texture (crunch) similar to a conventionally processed fried snack but without the use of an oil frying process, and (2) an improved texture (crunch) over conventionally dried non-oil processed snack (air dryer, microwave air dried, freeze-dried, etc.). The method of the present invention includes the steps of making dried snack from slices of vegetable/fruit, chopped or pureed vegetable/fruit, pomace or combinations thereof, or mixtures made up of these plus other ingredients for binding or bulking (referred to as substrate), and may include a pretreatment step, an IR dry blanching step, applied matrix and/or a final drying step to achieve a low moisture, low water activity slice, piece, or fragment thereof, containing the majority of the flavor, color and nutrition of the starting material(s). A vegetable snack, such as a crunchy carrot slice produced by this method, is a low fat ready to eat snack/ingredient having a crunchy texture, and having retained the fresh carrot flavor, color and nutrition of the starting material. The methods produce good tasting, low calorie, and nutritious, savory snack foods, without large amounts of sugar, saturated fat or Trans fatty acids. This results in a nutritious, savory ingredient and/or snack food.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 shows an exemplary process for producing shelf-stable, low-fat crunchy vegetable-based or fruit-based snacks.

FIG. 2 shows an exemplary chart depicting the effect of processing treatments on the organoleptic properties of the final dried vegetable.

FIG. 3 shows an exemplary chart of texture analysis data showing the distance between contact and fracture (in millimeters) and the peak force required to break the crunchy vegetable snack (in Newtons).

FIGS. 4A-4D show exemplary charts correlating organoleptic and texture analyzer measurements.

FIGS. 5A-5D shows exemplary effects of process treatment on Fruit/Vegetable Microstructure.

For a more complete understanding of the above and other features and advantages of the invention, reference should be made to the following description of the preferred embodiments.

### DESCRIPTION

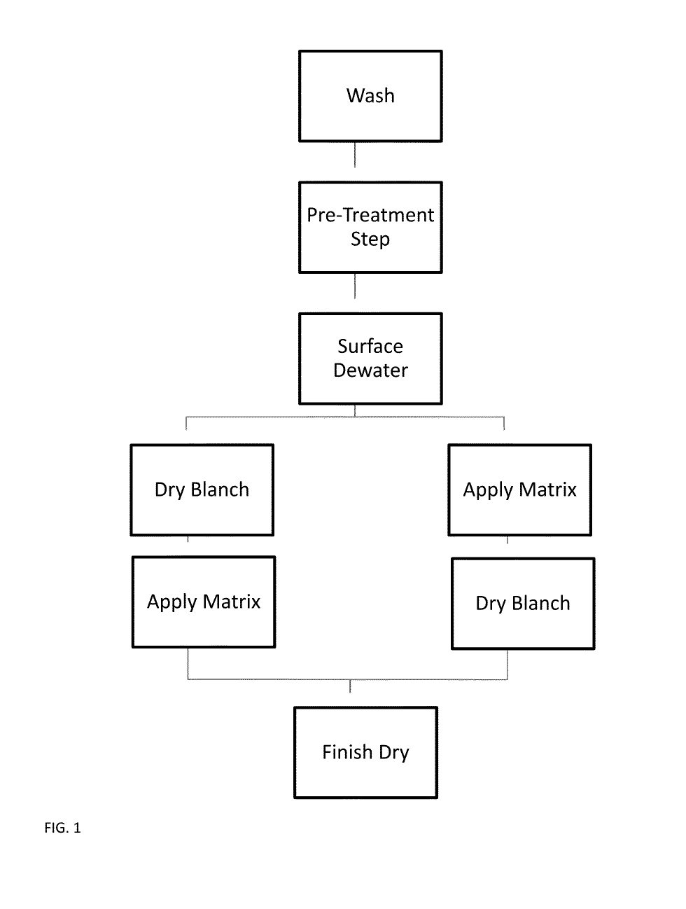

FIG. 1 shows an exemplary process for producing shelf-stable, low-fat crunchy vegetable or fruit-based snacks. The process includes washing the vegetables fruits (20). Next, one or more pretreatment operations are applied (22), as detailed below. A surface dewater operation is done (24). Then, an dry blanch operation is done (30) followed by a matrix application (32). Alternatively, a matrix is applied (40), and then a dry blanch operation can be done. The finished products are dried (50).

In one embodiment for preparing the dried snack product, the input fruits or vegetables are washed, if intact, and then pretreated with an application that may include salt, acid, or other additives, with the effect of preserving or enhancing flavor, texture, color, or shape. There is an optional surface dewatering operation, input ingredients are exposed to infrared blanching/dehydration before or after a matrix is applied. The product is finish-dried in a dehydrator or oven.

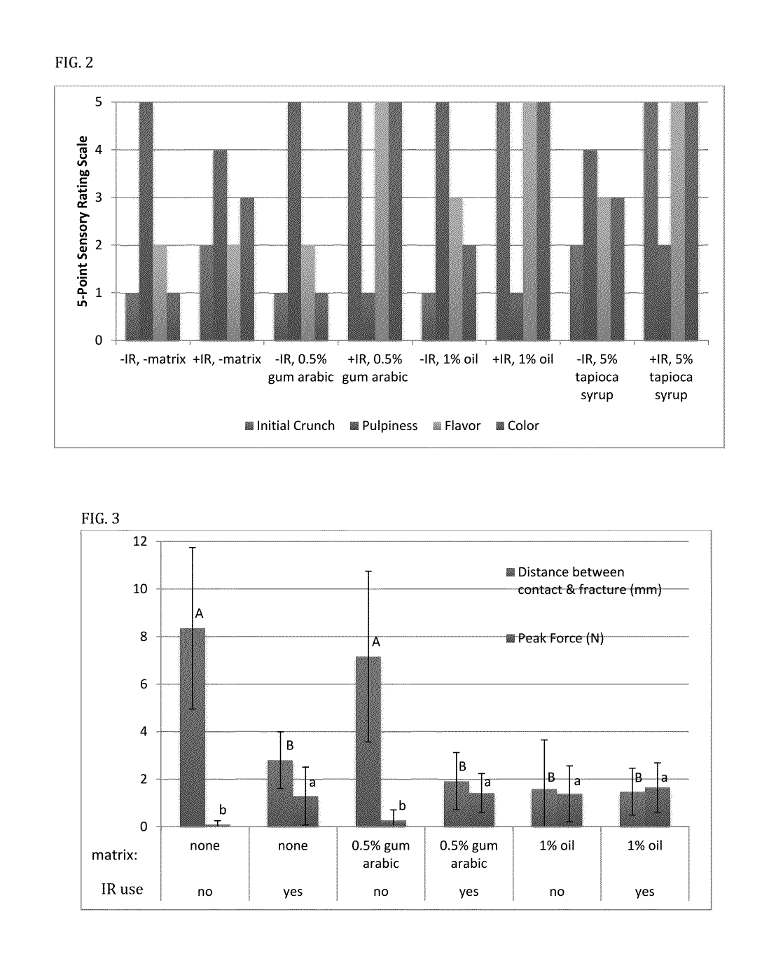

FIG. 2 illustrates the sensory perception of finished products. The treatments include IR as an example of dry blanching, matrix (gum arabic, oil or tapioca), and the organoleptic measurements include initial crunch, pulpiness, flavor, and color. Vegetable snacks with and without infrared treatment and with and without various added matrices were sensory tested on a 1-5 rating scale (1—lowest, 5—highest) for initial crunchiness within the first two bites, pulpiness (the texture of the product in the mouth after several moments of chewing), flavor, and color. Vegetable snacks that do not undergo infrared treatment show lower initial crunch, higher pulpiness, lower flavor, and lower color, as do vegetables that undergo infrared treatment but have no added matrix. Vegetable snacks that were infrared treated and additionally had one of several matrices scored higher on initial crunch, flavor, and color, and lower on pulpiness than vegetable snacks without infrared treatment or without the addition of one of the matrices.

FIG. 3 shows an exemplary chart of texture analysis data depicting two measurements: (1) the distance between contact and fracture (in millimeters) and (2) the peak force required to break the crunchy vegetable piece (in Newtons). Measurements were taken on a TA.XT2 texture analyzer machine with a ball probe and each sample spanning a hollow rigid tube 29 mm in internal diameter. Distance between contact and fracture measures the amount that the product bends before fracturing; less bending correlates to a crispier texture. Peak force measures the force required to fracture the product; a higher peak force correlates to a harder, crispier texture, although a very high peak force would indicate that the item is so hard it would not break.

For the texture measurement of distance between contact and fracture, snacks made with the combination of IR and matrix had a significantly smaller distance between contact and fracture, indicating less potential to bend, and more potential to break. This demonstrates that IR with a matrix is integral in forming a snack with less bend.

For the texture measurement of peak force required to fracture the snack, IR blanching with or without a matrix) was shown to increase the peak force. This demonstrates that IR is integral to forming a high peak force/“crunchy” snack.

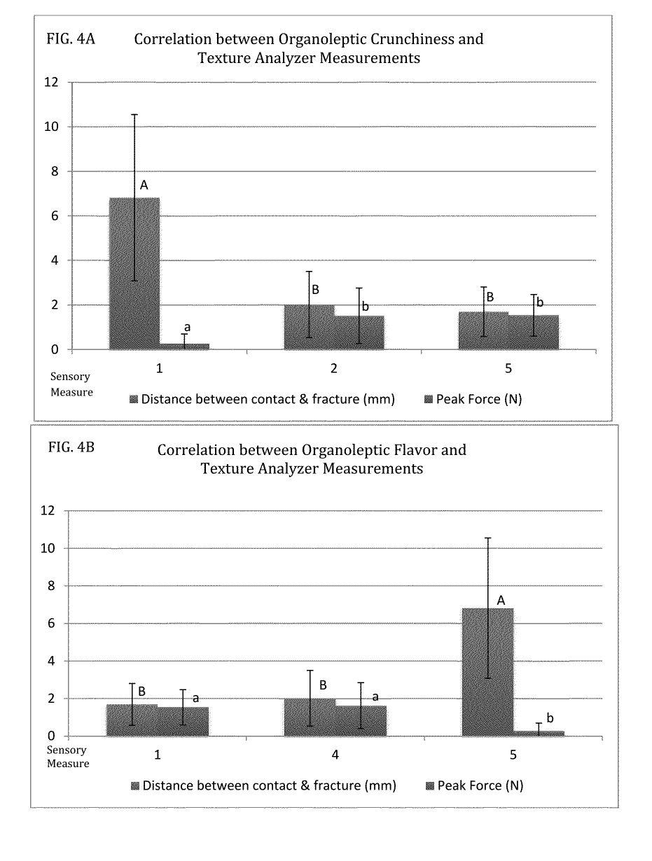

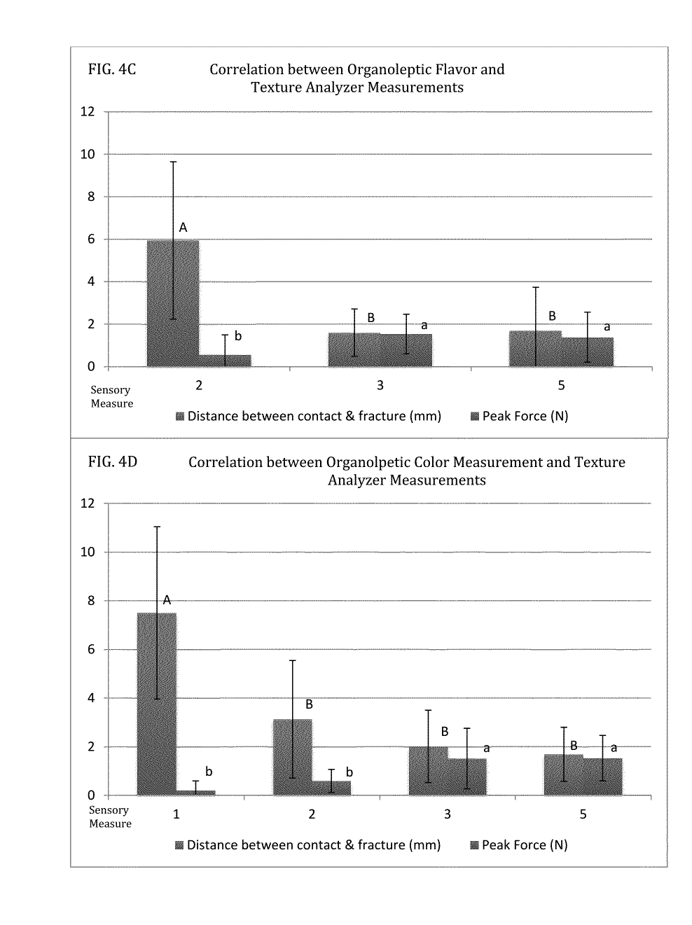

FIGS. 4A-4D depicts four charts showing the correlation of sensory data (initial crunchiness, pulpiness, flavor, and color on a 5-point rating scale) to texture analysis data (distance to fracture in millimeters and peak force in Newtons). Tukey-Kramer means comparison tests were used to compare average texture results of samples within each sensory rating bin; significant differences in distance to fracture are marked with different capital letters, while significant differences in peak forces are marked with different lower case letters.

Vegetable snacks that were organoleptically lowest in crunchiness, flavor and color, highest in pulpiness, were significantly more able to bend and less hard/crisp.

Results show that a small distance between contact and fracture, combined with a high peak force measurement, correlate to an organoleptically crunchy, non-pulpy, flavorful and colorful snack.

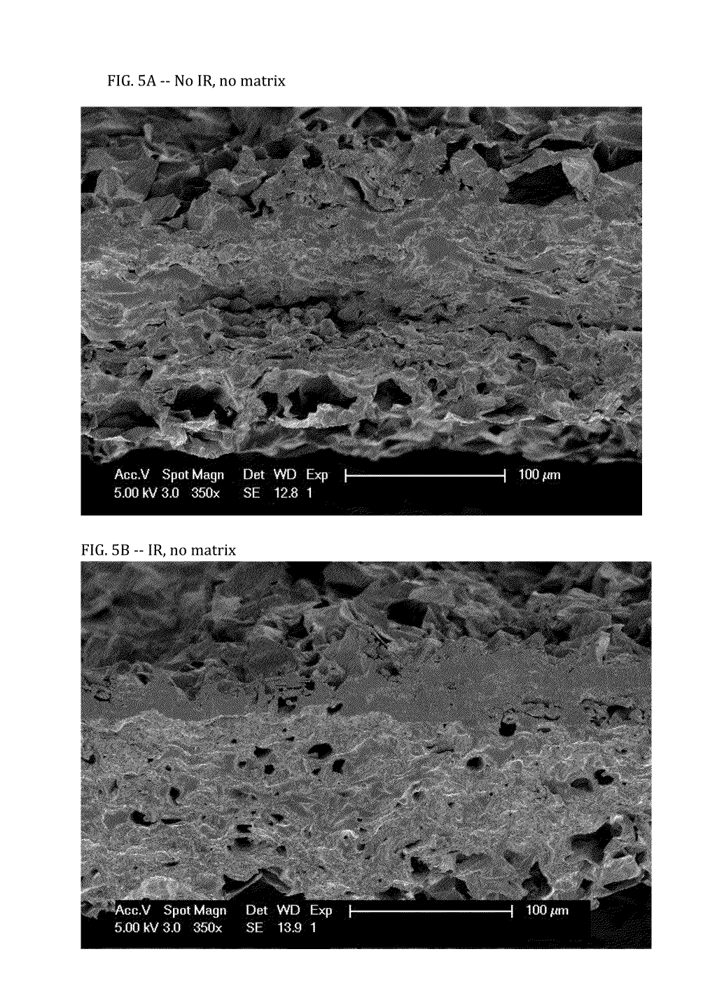

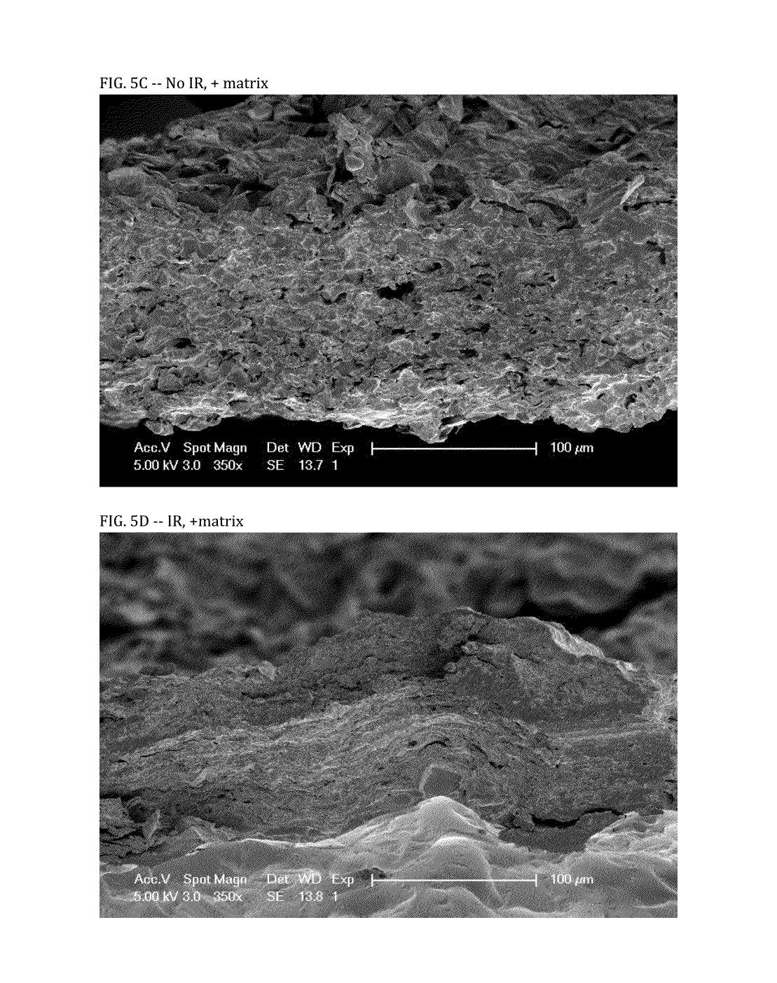

FIGS. 5A-5D depicts the measurement of product microstructure using Scanning Electron Microscopy SEM). The scanning electron micrographs shown are of an example vegetable with and without SIRBHAD treatment, and with and without matrix. The surfaces of the products change with the treatment, as does the amount of interstitial space within the tissue. IR treatment changes the product surface microstructure from irregular to more smooth and solidified, and reduces the residual interstitial space within the tissue. The addition of the matrix with IR resulted in a complete decrease of the interstitial spaces to the point of tissue compression and cementation, and smoothing of the product surface microstructure.

The results indicate that IR treatment and the addition of one of several select matrices cause plant tissue cementation, decrease of residual interstitial space, and smoother product surface microstructure, which correlate with organoleptically higher initial crunchiness and lower pulpiness.

In one example, carrots are sliced and dipped in an ascorbic acid solution where they soak up about 3% of their initial weight. A thin layer of the carrot slices is then loaded into the far-infrared blancher for 95 seconds of treatment, wherein they lose 20-60% of their initial weight worth of moisture. After which, they are coated with a gum arabic and maltodextrin solution and further dehydrated in a circulating hot air dryer for a minimum of 2 hours to a water activity level of less than 0.2.

In another example, beet pulp left over from a juicing machine is mixed with 20% of its initial weight worth of tapioca flour. The beet pulp is then rolled into a uniform layer and loaded into the far infrared blancher for 4 minutes of treatment, wherein it loses 5-70% of its initial weight-worth of moisture. After which, it is shaped into a thin layer and dried on a air dryer for 1.5 hours to a water activity of less than 0.2.

The instant process combines IR blanching with the application of a matrix before the final drying operation to produce a final dried vegetable or fruit that has a pleasant crunch similar to that commercially attained with frying. However, our crunchy dried fruit/vegetables have no or minimal added fat, and maintain more of their flavor, nutrition and color compared to those produced by conventional frying.

In particular, the processing fruits and vegetables can include an exposure of the vegetable/fruit to a selected band of infrared radiation at between 0.78 and 1000 micrometers, aimed at heating the substrate's constituent water, proteins, lipids, or carbohydrates, targeted alone or in combination. Additionally, a matrix is used to modify the microstructure of the fruit/vegetable thereby positively altering the organoleptic properties (flavor, texture, color) of final dried vegetable or fruit. The IR “heating/dry blanching” (1) minimizes/deactivates the enzyme(s) that are often deleterious to flavor (2) provides a kill operation for any bacteria that may have survived the wash, pretreatment operation (3) removes water. The use of the matrix in combination with IR heating/dry blanching will further change the microstructure, creating a compact structure with minimal pores or interstitial spaces visibly remaining in micrographs. The process without infrared treatment, but with addition of a matrix alone, does not accomplish this change in three-dimensional structure. This change in physical structure correlates to improved organoleptic properties and the retention of flavor, color and nutrients in the final dried product. The addition of a matrix to the substrate can occur before or after IR. The final operation in the process is the removal of water to a moisture content of between <1% and 7%, and a water activity between <0.2 and 0.6. This drying operation can be achieved using known techniques, such as, but not exclusively, air drying, vacuum drying, microwave drying. It is the unique combination of unit operations and the types of ingredients used in the matrix that produce a low-fat, dried, crunchy, highly nutritious, flavorful, colorful snack that can be eaten alone or used as an ingredient in snack composites or mixtures. It is unexpected to be able to utilize the unit operations and matrix ingredients with a fruit or vegetable to form a three dimensional structure resulting in fried-like crunchy texture.

To the extent that it is desired to include sweetness in the snack, natural sources of sweetness include sucrose (liquid or solids): cassava tuber or yucca root (liquid or solids), glucose, fructose, palm sugar and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Mono and disaccharide solids are typically present in the product at from 2-20 wt. %, especially 0.1-10 wt. %, especially 0.5-5 wt. %.

If it is desired to include a bulking agent in the food, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches, subject to the desire to minimize sweet carbohydrates expressed above.

Flavorings may be added to the snack in amounts that will impart a savory flavor. Subject to the desire to provide an overall savory impression, the flavoring may be any of the commercial flavors employed in nutrition bars or other food bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic tastes and typical flavors. The hand held snacks are flavored to taste. Suitable flavorants may also include seasoning, such as salt (sodium chloride) or potassium chloride. Flavorings which mask off-tastes from vitamins and/or minerals and other ingredients are preferably included in the products of the invention. The flavorants may be present at from 0.25 to 5 wt. % of the food, excluding salt or potassium chloride, which is generally present at from 0 to 1.5%, especially 0.1 to 0.5%.

The snack food may include colorants. Colorants are generally in the food at from 0 to 2 wt. %, especially from 0.1 to 1%.

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “comprising,” “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A method for producing food, comprising
a. pre-treating an edible item with one or more solutions to preserve or enhance texture, color, or flavor of the item, wherein the item is a fruit or a vegetable;
b. either (a) blanching with far-infrared, pulsed electric field, or microwave treatment and then applying a coating matrix; or (b) applying a coating matrix and then blanching with far-infrared, pulsed electric field, or microwave treatment;
c. bringing a final water content to less than 6% with a finishing dehydration operation; and
d. Obtaining a final product that is a shelf-stable, low-fat crunchy vegetable-based or fruit-based ingredient or snack.

2. The method of claim 1, wherein the pre-treating applies a solution containing weak acid or acids.

3. The method of claim 1, wherein the pre-treating applies a solution containing mineral salt or salts.

4. The method of claim 1, wherein the coating matrix comprises starches, syrups, and gums.

5. The method of claim 4, wherein the coating matrix comprises potato, tapioca, gum arabic, maltodextrin, and/or cellulose

6. The method of claim 1, wherein the coating matrix comprises oil at a level between about 0.5%-20% of the final product.

7. The method of claim 4, wherein the coating matrix is applied before dry blanching to process starches that have not been pre-gelatinized, but may become gelatinized during the blanching.

8. The method of claim 4, wherein the coating matrix may be comprised of a very small amount of oil (not necessarily, but possibly, as little as 1% compared to fruit/veg fresh weight).

9. The method of claim 1, comprising applying infrared radiation with a wavelength between 0.78 micrometers and 1000 micrometers.

10. The method of claim 1, comprising applying infrared radiation with a wavelength between 1-12 micrometers.

11. The method of claim 1, comprising applying infrared radiation with an intensity between 3000-5000 W/m².

12. The method of claim 1, wherein the finishing dehydration operation occurs between 50 and 165 degrees Celsius.

13. The method of claim 1, comprising inactivating endogenous enzymes of the fruit or vegetable.

14. The method of claim 13, comprising inactivating enzymes that cause loss of color, nutrition, texture, or flavor.

15. The method of claim 1, wherein the final product substantially retains original micronutrients.

16. The method of claim 15, comprising retaining vitamin C or beta carotene.

17. The method of claim 1, wherein the final product substantially retains the original vegetable or fruit flavor.

18. The method of claim 1, wherein the combination of infrared, pulsed electric field, or microwave treatment and the coating matrix on the fruit or veg creates a different/novel three dimensional structure, which shatters during initial stages of chewing, and wherein the coating matrix melts or dissolves rather than producing a viscous sensation upon rehydration in the mouth.

19. The method of claim 1, wherein the combination of dry blanching and the matrix compresses plant tissue to provide a crunchy texture that is less flexible and requires a higher peak force to fracture.

20. A method for making a low fat, low sugar dried vegetable or fruit snack, comprising:
a. pre-treating an edible item with one or more solutions to preserve or enhance texture, color, or flavor of the item, wherein the item is a fruit or a vegetable;
b. either (a) blanching with far-infrared, pulsed electric field, or microwave treatment and then applying a coating matrix; or (b) applying a coating matrix and then blanching with far-infrared, pulsed electric field or microwave treatment;
c. providing a texture (crunch) of a fried snack without oil frying or dried non-oil processed snack while preserving flavor, color and nutrition of the original vegetable or fruit.

21. The method of claim 20, comprising forming a crunchy carrot slice as a low fat ready to eat ingredient or snack having a crunchy texture, and having retained a fresh carrot flavor, color and nutrition of a carrot.
